(19) United States
(12) Patent Application Publication
(10) Pub. No.: US 2023/0359658 A1
(43) Pub. Date: Nov. 9, 2023

(54) BUSINESS MATCHING SUPPORT DEVICE, BUSINESS MATCHING SUPPORT METHOD, AND PROGRAM

(71) Applicant: KONICA MINOLTA, INC., Tokyo (JP)

(72) Inventors: Nofumi MIZUMOTO, Nara-shi (JP); Hideyuki MATSUDA, Osaka (JP); Yutaka YASUNAGA, Osaka (JP)

(73) Assignee: KONICA MINOLTA, INC., Tokyo (JP)

(21) Appl. No.: 18/312,344

(22) Filed: May 4, 2023

(30) Foreign Application Priority Data
May 9, 2022 (JP) 2022-076965

(51) Int. Cl. G06F 16/35; G06F 16/31; G06Q 10/0637; G06F 40/284

(52) U.S. Cl. CPC G06F 16/35; G06F 16/313; G06F 40/284; G06Q 10/0637

(57) ABSTRACT

A business matching support device includes: a hardware processor that: acquires company information of a company searching for a matching candidate destination; extracts a phrase relating to the company from the company information; creates a search keyword group by excluding a phrase included in information on a competitor of the company from a plurality of the extracted phrases; and searches a predetermined database using the search keyword group to extract the matching candidate destination.

The entire disclosure of Japanese patent Application No. 2022-076965, filed on May 9, 2022, is incorporated herein by reference in its entirety.

### BACKGROUND

### Technological Field

The present invention relates to a business matching support device, a business matching support method, and a program that support work when extracting a business matching candidate.

### Description of the Related Art

In recent years, for the purpose of business development and the like, a business matching service for introducing a candidate destination that can be a business partner to a requesting company has been performed. Conventionally, in this type of business matching, in order to introduce a company having a high possibility of getting a contract to a requesting company, it has been proposed to automatically collect information on the company from a company information providing device, automatically analyze a factor of a contract for each matching pattern based on the collected information to generate an evaluation formula for each matching pattern, and provide an evaluation value of a company to be a matching candidate destination using the evaluation formula (for example, JP No. 2020-201819 A). In this conventional technique, words extracted from the collected information are analyzed to generate a company feature matrix, and past transaction log information is classified for each matching pattern based on the company feature matrix, thereby generating the evaluation formula for each matching pattern.

However, in the above-described conventional technique, the information collected from the company information providing device also includes information on a competitor of the requesting company. Therefore, the competitor of the requesting company is also extracted as a matching candidate company. However, in practice, since a competitor of the requesting company cannot be a matching candidate destination, there is a problem that it takes time to select an appropriate matching candidate destination and efficiency is poor.

### SUMMARY

The present invention has been made to solve the above-described conventional problems, and an object of the present invention is to provide a business matching support device, a business matching support method, and a program that support work to be performed efficiently in extracting a business matching candidate.

To achieve the abovementioned object, according to an aspect of the present invention, a business matching support device reflecting one aspect of the present invention comprises: a hardware processor that: acquires company information of a company searching for a matching candidate destination; extracts a phrase relating to the company from the company information; creates a search keyword group by excluding a phrase included in information on a competitor of the company from a plurality of the extracted phrases; and searches a predetermined database using the search keyword group to extract the matching candidate destination.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a configuration example of a business matching support system;

FIG. 2 is a block diagram illustrating a functional configuration of a business matching support device;

FIG. 3 is a diagram illustrating company information acquired by a company information acquisition unit;

FIG. 4 is a flowchart illustrating a first example of a specific processing procedure of the business matching support device;

FIG. 5 is a flowchart illustrating an example of a detailed processing procedure of first phrase group generation processing;

FIG. 6 is a flowchart illustrating an example of a detailed processing procedure of search keyword group creation processing;

FIG. 7 is a diagram illustrating a first phrase group;

FIG. 8 is a diagram illustrating an example in which a phrase of a lower rank is excluded from the first phrase group;

FIG. 9 is a diagram illustrating an example in which a phrase of a higher rank is excluded from the first phrase group;

FIG. 10 is a diagram illustrating an example of a search keyword group created from the first phrase group;

FIG. 11 is a flowchart illustrating a second example of a specific processing procedure of the business matching support device;

FIG. 12 is a flowchart illustrating a third example of a specific processing procedure of the business matching support device;

FIG. 13 is a flowchart illustrating a detailed processing procedure of search keyword group creation processing;

FIG. 14 is a diagram illustrating an example in which a phrase of a higher rank in a second phrase group is excluded from the first phrase group;

FIG. 15 is a diagram illustrating an example of a search keyword group created from the first phrase group;

FIG. 16 is a flowchart illustrating a fourth example of a specific processing procedure of the business matching support device;

FIG. 17 is a flowchart illustrating a detailed processing procedure of search keyword group creation processing; and

FIG. 18 is a diagram illustrating an example of a search keyword group created from the first phrase group.

### DETAILED DESCRIPTION OF EMBODIMENTS

Hereinafter, one or more preferred embodiments of the present invention will be described in detail with reference to the drawings. However, the scope of the invention is not limited to the disclosed embodiments. Note that, in the embodiments described below, elements common to each other are denoted by the same reference signs, and redundant description thereof will be omitted.

### Basic Embodiment

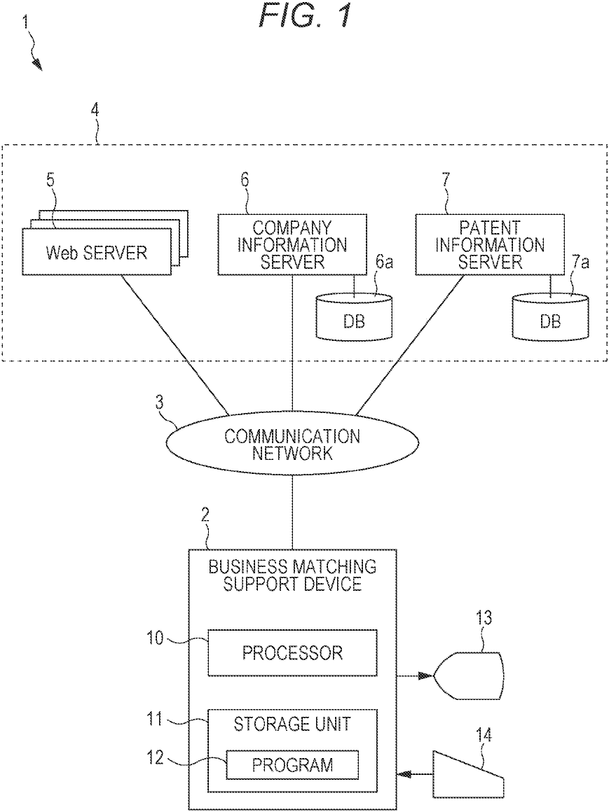

FIG. 1 is a diagram illustrating a configuration example of a business matching support system 1 according to an embodiment of the present invention. The business matching support system 1 is, for example, a system that outputs a matching candidate destination that can be a business partner of a company based on a request from the company searching for a business matching candidate destination (Hereinafter, referred to as a “matching candidate destination”.). The business matching support system 1 includes a business matching support device (Hereinafter, simply referred to as a “support device”.) 2 and a company information providing device 4, and these devices can perform data communication with each other via a communication network 3. The communication network 3 is a network including a local area network (LAN) and a wide area network (WAN). The communication network 3 also includes the Internet.

The support device 2 is a device having a main function in the business matching support system 1, acquires company information of a company searching for a matching candidate destination, and extracts a matching candidate destination that can be a business partner on the basis of the company information. The support device 2 is configured by, for example, a computer, and includes a processor 10, a storage unit 11, a display unit 13, and an operation input unit 14. The processor 10 is a hardware processor including, for example, a central processing unit (CPU), and reads and executes a program 12 stored in the storage unit 11. The storage unit 11 is a storage device including, for example, a hard disk drive or a solid state drive, and stores the computer readable program 12. The display unit 13 includes a color liquid crystal display or the like, and can display various types of information on a display screen. The operation input unit 14 includes, for example, a keyboard, a mouse, and the like, and receives an input operation by a user.

The company information providing device 4 is a device that provides various company information to the support device 2 via the communication network 3. For example, the company information providing device 4 includes a plurality of servers accessible by the support device 2. FIG. 1 illustrates a configuration example in which the company information providing device 4 includes a plurality of Web servers 5, a company information server 6, and a patent information server 7.

Each of the Web servers 5 is a web server independently installed by each of a plurality of companies, and is a server that provides advertising homepages and the like of each company as company information. Therefore, the support device 2 can acquire the company information from the Web servers 5 by accessing the Web servers 5.

The company information server 6 is a server that holds company information of a plurality of companies and reads and provides necessary company information from the company information of the plurality of companies. For example, the company information server 6 has a company information database 6a, and registers and manages company information of various companies in the company information database 6a. The company information registered in the company information database 6a includes, for example, various types of information such as a business that the company is currently conducting, a business field that the company plans to expand in the future, handled products, provided services, a manufacturing base, a sales base, a research and development trend, a management policy, and a technical paper. Then, in a case where company information of a specific company is requested from the support device 2, the company information server 6 reads the company information of the specific company from the company information database 6a and provides the company information to the support device 2.

The patent information server 7 holds patent information of a plurality of companies, reads necessary patent information from among the patent information of the plurality of companies, and provides the patent information as company information. For example, the patent information server 7 has a patent information database 7a, and registers and manages patent information of various companies in the patent information database 7a. Then, in a case where patent information of a specific company is requested from the support device 2, the patent information server 7 reads the patent information of the specific company from the patent information database 7a, and provides the patent information as company information to the support device 2.

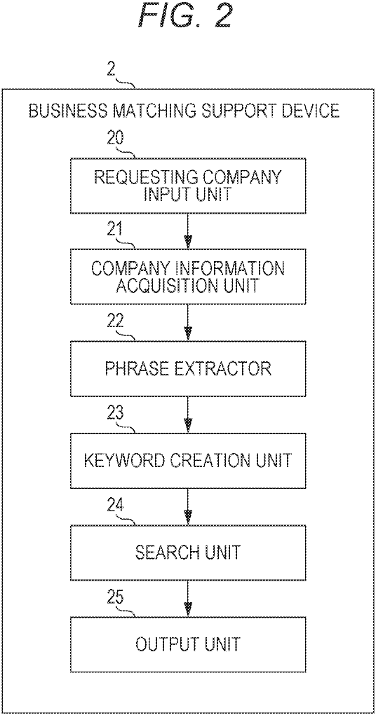

FIG. 2 is a block diagram illustrating a functional configuration of the support device 2. By reading and executing the program 12 in the storage unit 11, the processor 10 of the support device 2 functions the support device 2 as a requesting company input unit 20, a company information acquisition unit 21, a phrase extractor 22, a keyword creation unit 23, a search unit 24, and an output unit 25.

The requesting company input unit 20 inputs information regarding the requesting company that is a company searching for a matching candidate destination. For example, the requesting company input unit 20 receives an operation input of information regarding the requesting company via the operation input unit 14. Furthermore, the requesting company input unit 20 may receive an input of information regarding the requesting company from an external computer via the communication network 3. For example, the information regarding the requesting company may be information including a company name and the like.

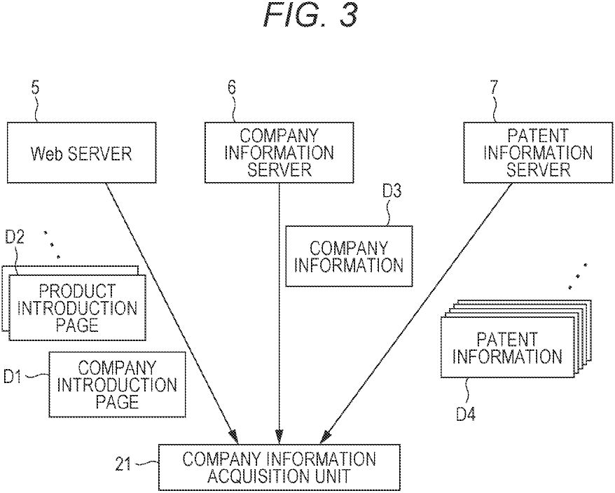

The company information acquisition unit 21 acquires company information of a company (requesting company) that is searching for a matching candidate destination on the basis of the information of the requesting company received by the requesting company input unit 20. FIG. 3 is a diagram illustrating the company information acquired by the company information acquisition unit 21. As illustrated in FIG. 3, the company information acquisition unit 21 acquires company information on the requesting company from each of the Web servers 5, the company information server 6, and the patent information server 7. For example, the company information acquisition unit 21 acquires a company introduction page D1, a product introduction page D2, and the like as company information from the Web server 5 of the requesting company. Furthermore, the company information acquisition unit 21 acquires company information D3 of the requesting company registered in the company information database 6a from the company information server 6. Moreover, the company information acquisition unit 21 acquires, from the patent information server 7, patent information D4 of the requesting company registered in the patent information database 7a as company information.

For example, the company information acquired from the company information providing device 4 by the company information acquisition unit 21 is text data. Therefore, the company information acquired by the company information acquisition unit 21 includes a phrase (word) representing a feature of the requesting company.

The phrase extractor 22 extracts a characteristic phrase (word) regarding the requesting company from the company information acquired by the company information acquisition unit 21. For example, in a case where the company information includes a sentence, the phrase extractor 22 performs morphological analysis on the sentence of the company information, discriminates a part of speech of each morpheme in the sentence, and extracts a word such as a noun or a verb representing a feature of the requesting company as a characteristic phrase related to the requesting company. At this time, the phrase extractor 22 may extract terminology and technical terms in the current or future business field of the requesting company as a characteristic phrase regarding the requesting company. For example, the phrase extractor 22 can extract a characteristic phrase related to the requesting company on the basis of the patent information D4 of the requesting company acquired from the patent information server 7, thereby extracting terminology or technical terms included in a patent group filed with the Patent Office by the requesting company as a characteristic phrase.

Furthermore, since the phrase extractor 22 extracts a phrase from each of the company introduction page D1, the product introduction page D2, the company information D3, and the patent information D4, the same phrase may be redundantly extracted. For example, the phrase extractor 22 may extract a plurality of the same terminology or technical terms from one patent document included in the patent information D4 in an overlapping manner.

The keyword creation unit 23 creates a search keyword group from a plurality of phrases extracted by the phrase extractor 22. The search keyword group is information in which keywords used for searching a matching candidate destination are registered.

Here, the keyword creation unit 23 does not register all phrases extracted by the phrase extractor 22 in the search keyword group. This is because a characteristic phrase related to the requesting company may be common with a phrase representing a characteristic of a competitor of the requesting company, and when all phrases extracted by the phrase extractor 22 are registered in the search keyword group and a matching candidate destination is searched, many competitors of the requesting company hit the search keyword group, and the matching candidate destination cannot be efficiently selected.

In order to prevent this, the keyword creation unit 23 excludes a phrase common to a phrase representing a competitor of the requesting company from a plurality of phrases extracted by the phrase extractor 22, and creates a search keyword group. As a result, when the matching candidate destinations are searched using the keywords included in the search keyword group, a large number of competitors of the requesting company can be prevented from being detected, and the matching candidate destinations of the requesting company can be efficiently selected.

The search unit 24 acquires a search keyword group created by the keyword creation unit 23, and searches for a matching candidate destination of the requesting company on the basis of the keywords included in the search keyword group. For example, the search unit 24 searches the company information database 6a of the company information server 6 or the patent information database 7a of the patent information server 7 based on the keywords included in the search keyword group, and extracts a matching candidate destination of the requesting company. However, the database searched by the search unit 24 is not limited to the company information database 6a and the patent information database 7a, and may be another database. Furthermore, the search by the search unit 24 may include general Internet search.

As described above, phrases common to phrases representing competitors of the requesting company are excluded from the search keyword group created by the keyword creation unit 23. Therefore, when the search unit 24 performs a search using the keywords included in the search keyword group, the competitor of the requesting company is excluded, and a company suitable for the matching candidate of the requesting company can be efficiently detected.

The output unit 25 outputs a search result by the search unit 24. For example, the output unit 25 displays the search result on the display unit 13. Furthermore, the output unit 25 may transmit the search result to an external computer via the communication network 3.

As described above, the support device 2 according to the present embodiment includes: the company information acquisition unit 21 that acquires company information of a requesting company that is searching for a matching candidate destination; the phrase extractor 22 that extracts a characteristic phrase related to the requesting company from the company information; the keyword creation unit 23 that creates a search keyword group by excluding a phrase representing a competitor of the requesting company from among a plurality of phrases extracted by the phrase extractor 22; and the search unit 24 that extracts a matching candidate destination of the requesting company by searching a predetermined database using the search keyword group. According to such a configuration, it is possible to suppress many competitors of the requesting company from being detected by the search by the search unit 24, and thus, it is possible to efficiently extract the matching candidate destinations of the requesting company.

### First Example

Next, a specific first example of the basic embodiment described above will be described. In the first example, one method of excluding a phrase representing a competitor of a requesting company from a plurality of phrases extracted from company information of the requesting company is exemplified.

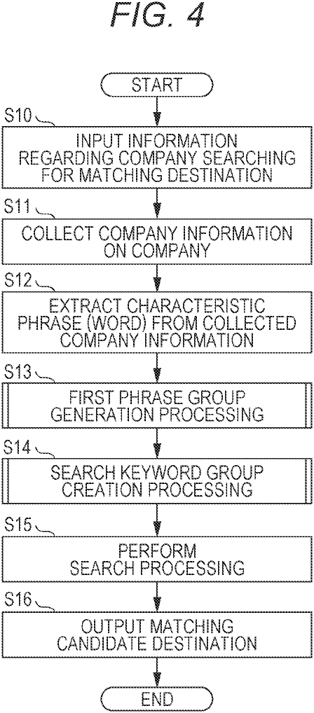

FIGS. 4 to 6 are flowcharts illustrating a first example of a specific processing procedure of the support device 2. This processing is performed by the processor 10 of the support device 2 executing the program 12. As illustrated in FIG. 4, when the support device 2 starts this processing, the requesting company input unit 20 functions and inputs information regarding a requesting company searching for a matching candidate destination (step S10). When the information regarding the requesting company is input, the support device 2 causes the company information acquisition unit 21 to function. Then, based on the information regarding the requesting company, the support device 2 collects company information regarding the requesting company from the company information providing device 4 including each of the Web servers 5, the company information server 6, and the patent information server 7 (step S11).

When collecting the company information of the requesting company, the support device 2 causes the phrase extractor 22 to function. Then, the support device 2 extracts a characteristic phrase (word) regarding the requesting company from the company information of the requesting company (step S12). For example, as described above, the support device 2 performs morphological analysis on the collected company information, and extracts all characteristic phrases such as terminology and technical terms representing the requesting company.

Subsequently, the support device 2 activates the keyword creation unit 23 to execute first phrase group generation processing (step S13). The first phrase group generating processing is processing of generating a first phrase group obtained by ranking a plurality of phrases extracted by the phrase extractor 22 on the basis of the appearance frequency.

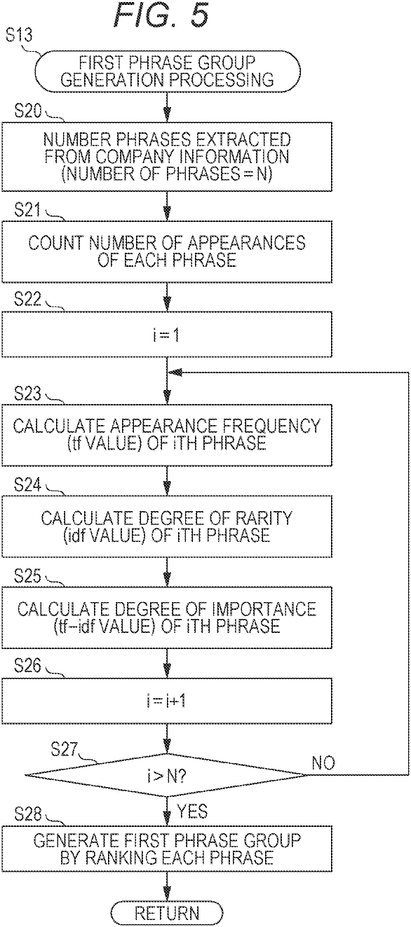

FIG. 5 is a flowchart illustrating an example of a detailed processing procedure of the first phrase group generation processing (step S13). When starting the first phrase group generation processing, the keyword creation unit 23 first numbers a plurality of phrases extracted from the company information of the requesting company (step S20). The phrases to be numbered are different phrases. Therefore, even in a case where a plurality of the same phrases are redundantly extracted from the company information, only one phrase is numbered. For example, in a case where 10 different phrases are extracted from the company information, the keyword creation unit 23 individually assigns a number of 1 to 10 to each of the 10 phrases. Therefore, when the number of phrases extracted from the company information is N, the keyword creation unit 23 assigns the numbers 1 to N to each phrase.

Next, the keyword creation unit 23 counts the number of appearances of each phrase extracted from the company information (step S21). For example, in a case where the same phrase is redundantly extracted from the company information, the keyword creation unit 23 counts the number of appearances by counting the number of redundantly extracted phrases.

Next, the keyword creation unit 23 initializes a variable i to 1 (step S22). Then, the keyword creation unit 23 focuses on the ith phrase among the phrases numbered from 1 to N, and calculates an appearance frequency of the ith phrase (step S23). For example, the keyword creation unit 23 calculates a term frequency (tf) value generally used in evaluating a degree of importance of a word as the appearance frequency of the ith phrase. In this case, for example, the tf value is derived by the following Formula 1.

$$\text{tf value} = \frac{\text{Number of appearances of ith phrase}}{\text{Sum of number of appearances of all phrases}} \qquad \text{[Mathematical Formula 1]}$$

That is, the tf value is calculated by an operation in which the sum of the number of appearances of all phrases extracted from the company information is used as a denominator and the number of appearances of the ith phrase is used as a numerator, and indicates at what rate the ith phrase appears.

Subsequently, the keyword creation unit 23 calculates a degree of rarity of the ith phrase (step S24). For example, the keyword creation unit 23 calculates an inverse document frequency (idf) value, which is generally used when evaluating a degree of importance of a word, as a degree of rarity of the ith phrase. In this case, for example, the idf value is derived by the following Formula 2.

$$\text{idf value} = \text{log} \left(\frac{\text{Total number of documents}}{\text{Number of documents including ith phrase}}\right) \qquad \text{[Mathematical Formula 2]}$$

Here, the number of documents means the number of pieces of information acquired from the company information providing device 4. For example, each of the company introduction page D1 and the product introduction page D2 is one document. Furthermore, the company information D3 is also treated as one document. Furthermore, each of the patent documents included in the patent information D4 is handled as one document. For example, in a case where the patent information D4 includes a plurality of patent documents, the patent information D4 includes the number of documents corresponding to the number of patent documents. Therefore, the idf value indicates a high value when the ith phrase is rare, and indicates a low value when the ith phrase frequently appears in many documents (information).

Then, the keyword creation unit 23 calculates a degree of importance of the ith phrase (step S25). For example, the keyword creation unit 23 calculates the degree of importance of the ith phrase on the basis of the appearance frequency calculated in step S23 and the degree of rarity calculated in step S24. Specifically, the keyword creation unit 23 calculates the importance level of the ith phrase by calculating a tf-idf value. In this case, for example, the tf-idf value is derived by the following Formula 3.

$$\text{tf-idf value = tf value} ∗ \text{idf value} \qquad \text{[Mathematical Formula 3]}$$

As described above, the degree of importance of the ith phrase is a value obtained by multiplying the appearance frequency and the degree of rarity. Therefore, in the company information collected from the company information providing device 4, as the appearance frequency of the ith phrase increases, the importance of the phrase increases, and as the rarity of the ith phrase increases, the importance of the phrase increases. Therefore, by calculating the degree of importance of the ith phrase, it is possible to evaluate whether or not the ith phrase is an important phrase for the requesting company.

After calculating the degree of importance of the ith phrase, the keyword creation unit 23 adds 1 to the variable i and updates the variable i (step S26). Then, the keyword creation unit 23 determines whether or not the variable i exceeds the number of phrases N (step S27). In a case where the variable i does not exceed the number of phrases N (NO in step S27), the keyword creation unit 23 returns to step S23 and repeats the processing in steps S23 to S25 described above based on the updated variable i. By repeating the processing of steps S23 to S25, it is possible to calculate the importance of all phrases extracted from the company information of the requesting company.

In a case where the variable i exceeds the number of phrases N (YES in step S27), the keyword creation unit 23 generates a first phrase group by ranking each phrase extracted from the company information (step S28). At this time, the keyword creation unit 23 ranks each phrase on the basis of the degree of importance of each phrase extracted from the company information. For example, the keyword creation unit 23 assigns high ranks in descending order of importance.

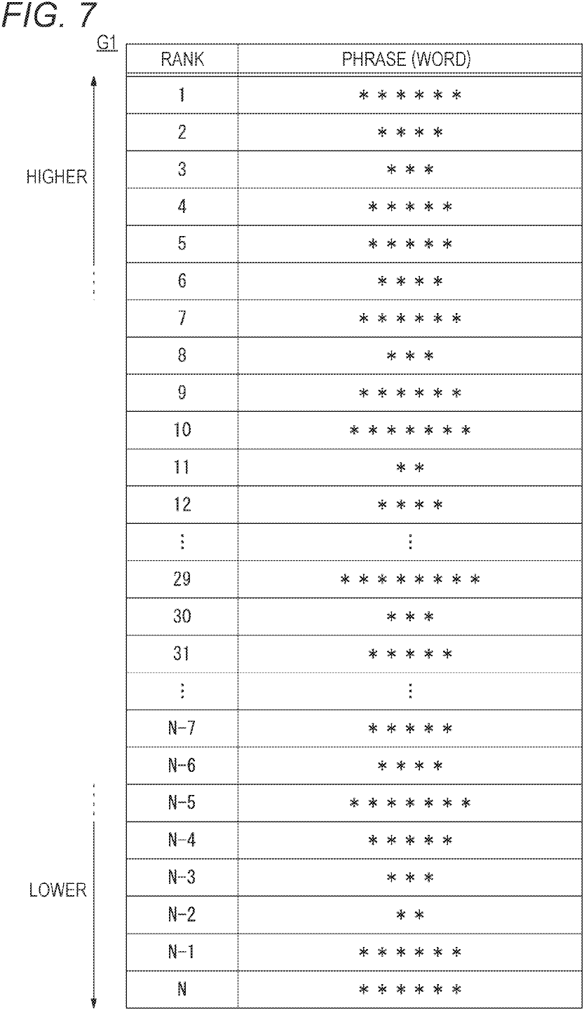

FIG. 7 is a diagram illustrating a first phrase group G1. As illustrated in FIG. 7, the keyword creation unit 23 ranks a plurality of (N) phrases extracted from the company information of the requesting company, and generates a list in which the phrases are arranged in rank order as a first phrase group G1. In the first phrase group G1, only phrases that do not overlap each other among phrases extracted from the company information are ranked. Note that, in FIG. 7, the smaller the numerical value of the rank, the higher the rank of the phrase. When generating the first phrase group G1 as illustrated in FIG. 7, the keyword creation unit 23 stores the first phrase group G1 in the storage unit 11. This completes the first phrase group generation processing.

Returning to the flowchart of FIG. 4, next, the keyword creation unit 23 executes search keyword group creation processing (step S14). The search keyword group creation processing is processing of excluding a phrase common to a phrase representing a competitor of the requesting company from a plurality of phrases included in the first phrase group G1, and creating a keyword group from which a company suitable for a matching candidate of the requesting company can be extracted.

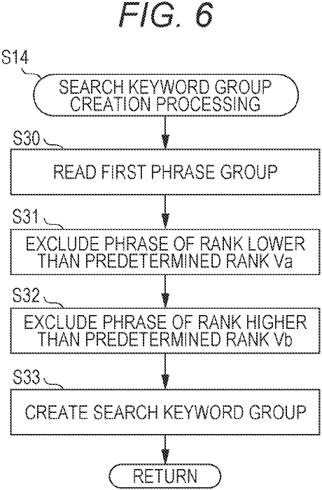

FIG. 6 is a flowchart illustrating an example of a detailed processing procedure of the search keyword group creation processing (step S14). When starting the search keyword group creation processing, the keyword creation unit 23 reads the first phrase group G1 stored in the storage unit 11 (step S30).

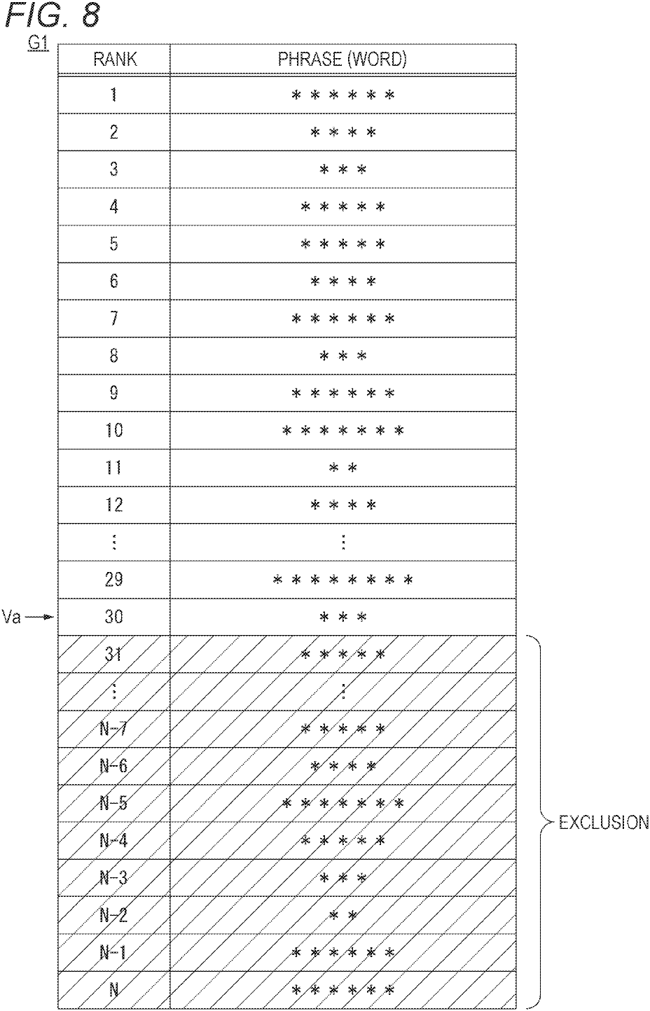

Subsequently, as illustrated in FIG. 8, the keyword creation unit 23 excludes a phrase arranged in a rank lower than the predetermined rank Va in the first phrase group G1 (step S31). A phrase ranked lower than the predetermined rank Va is a phrase having low importance for the requesting company. Therefore, when a phrase of a lower rank included in the first phrase group G1 is included in the search keyword, a company not suitable as a matching candidate destination of the requesting company is detected, and there is a possibility that many companies that become noise components are detected. In order to prevent this, the keyword creation unit 23 excludes a phrase ranked lower than the predetermined rank Va in the first phrase group G1 from the search keyword. In FIG. 8, the rank 30 is exemplified as the predetermined rank Va, but the predetermined rank Va is not limited to the rank 30, and can be arbitrarily set by the user who uses the support device 2. Furthermore, in a case where it is not necessary to prevent a large number of companies that become noise components from being detected when searching for a matching candidate destination of a requesting company, a processing procedure of skipping without performing the processing of step S31 may be adopted.

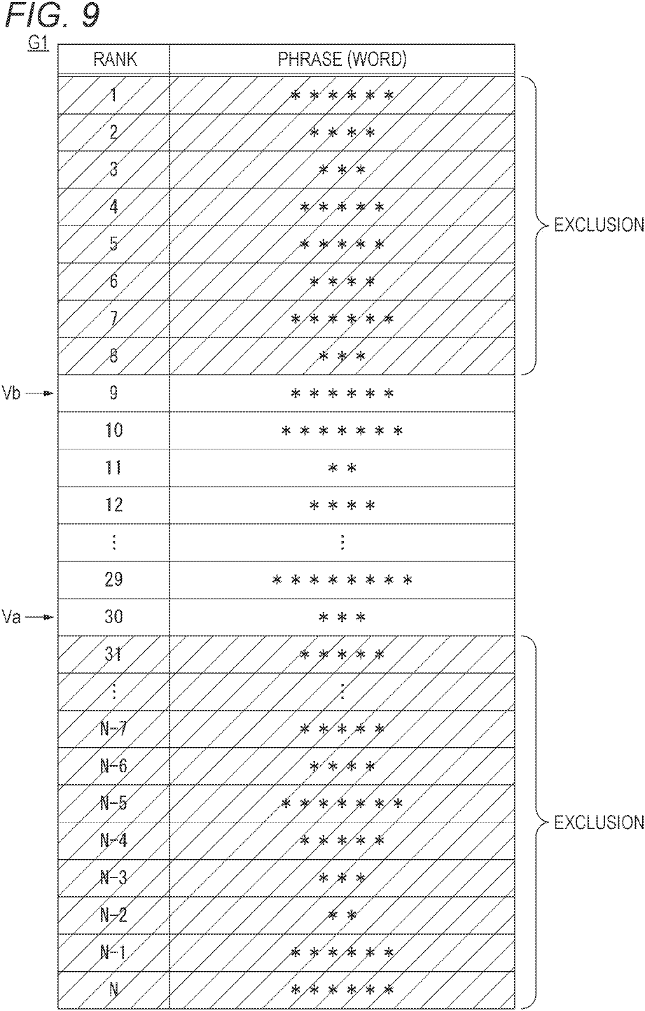

Next, as illustrated in FIG. 9, the keyword creation unit 23 excludes a phrase arranged in a rank higher than the predetermined rank Vb in the first phrase group G1 (step S32). A phrase ranked higher than the predetermined rank Vb is a phrase having high importance for a competitor of the requesting company, and is a phrase common to a phrase representing the competitor. Therefore, when a phrase of a high rank included in the first phrase group G1 is included in the search keyword, a competitor unsuitable for a matching candidate destination of the requesting company is detected. In order to prevent this, the keyword creation unit 23 excludes a phrase ranked higher than the predetermined rank Vb in the first phrase group G1 from the search keyword, and reduces detection of a competitor of the requesting company as a matching candidate destination. In FIG. 9, the rank 9 is exemplified as the predetermined rank Vb, but the predetermined rank Vb is not limited to the rank 9, and can be arbitrarily set by the user who uses the support device 2. However, the predetermined rank Vb needs to be a value higher than the predetermined rank Va adopted in step S31.

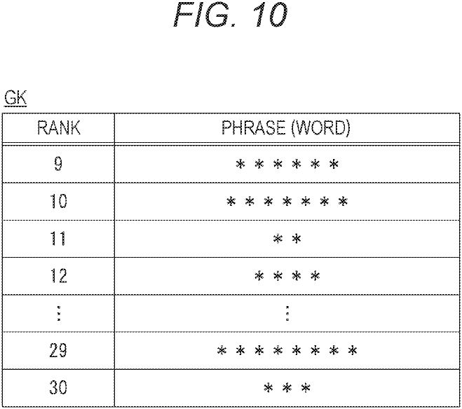

Next, the keyword creation unit 23 creates a search keyword group using phrases that are not excluded in the first phrase group G1 (step S33). FIG. 10 is a diagram illustrating an example of a search keyword group GK created from the first phrase group G1. As illustrated in FIG. 10, the search keyword group GK includes a plurality of phrases (keywords) used when searching for a matching candidate destination of a requesting company. Furthermore, as described above, phrases representing competitors of the requesting company are excluded from phrases included in the search keyword group GK. Therefore, when the plurality of phrases included in the search keyword group GK are used to search for a company that is a matching candidate destination, the possibility that a competitor of the requesting company is detected can be reduced. Furthermore, phrases having low importance for the requesting company are also excluded from the phrases included in the search keyword group GK. Therefore, when a company that is a matching candidate destination is searched using a plurality of phrases included in the search keyword group GK, a possibility that a company that is not suitable as a matching candidate destination of the requesting company is detected can be suppressed to be low. Thus, the search keyword group creation processing ends.

Returning to the flowchart of FIG. 4, next, the support device 2 activates the search unit 24 and executes search processing (step S15). The search unit 24 searches for a company that is a matching candidate destination of the requesting company using a phrase (keyword) included in the search keyword group GK created by the keyword creation unit 23. In a case where a plurality of phrases are included in the search keyword group GK, the search unit 24 searches for a company as a matching candidate destination by performing an AND search or an OR search using the plurality of phrases. That is, the search unit 24 extracts, as a matching candidate destination of the requesting company, another company in which a phrase common to the terminology and the technical term extracted as a phrase representing the requesting company is included in the company information. At this time, the search unit 24 can avoid detection of many competitors of the requesting company by performing a search using phrases included in the search keyword group GK. Furthermore, when a phrase of a lower rank in the first phrase group G1 is excluded in the search keyword group GK, it is possible to avoid detection of many companies that are not competitors of the requesting company but are not suitable as matching candidate destinations of the requesting company. Therefore, the search unit 24 can efficiently detect the company that is the matching candidate destination of the requesting company by performing the search using the phrases included in the search keyword group GK. Thereafter, the support device 2 activates the output unit 25 and outputs the matching candidate destination detected by the search by the search unit 24 (step S16).

As described above, the support device 2 of the present example adopts, as a method of excluding a phrase representing a competitor of a requesting company from a plurality of phrases extracted from company information of the requesting company, a method of ranking a plurality of phrases extracted from the company information according to the degree of importance, and excluding a phrase of a high rank having a high possibility of being common with the phrase representing the competitor of the requesting company to create the search keyword group GK. There is an advantage that it is possible to efficiently perform processing when creating the search keyword group GK in the support device 2 by uniformly excluding phrases of a high rank which are highly likely to be common to phrases representing competitors of the requesting company.

For example, when the matching candidate destination of the requesting company is searched by applying the present example, a detection rate of a company suitable as the matching candidate destination of the requesting company is 40% or more. On the other hand, as a comparative example, when the search keyword group GK is created without performing the processing of step S32 in the flowchart of FIG. 6 and a search is performed using phrases included in the search keyword group GK, the detection rate of a company suitable as a matching candidate destination of the requesting company is less than 40%. That is, in the present example, since the detection rate of the competitor of the requesting company is lower than that in the comparative example, it is possible to improve the detection rate of the company suitable as the matching candidate destination of the requesting company.

Note that, in the present example, an example of calculating the tf value, the idf value, and the tf-idf value in order to evaluate the degree of importance of the plurality of phrases extracted from company information has been described. However, the invention is not limited thereto, and the support device 2 may calculate another index in order to evaluate the degree of importance of the plurality of phrases.

### Second Example

Next, a second example will be described. In the first example described above, the plurality of phrases extracted from the company information are ranked according to the degree of importance, and phrases of a high rank that are highly likely to be common to phrases representing competitors of the requesting company are uniformly excluded. Therefore, there is a possibility that a matching candidate destination useful for the requesting company cannot be detected only with phrases left in the search keyword group GK. Therefore, in the second example, a processing procedure that improves the processing procedure of the first example described above and enables detection of a matching candidate destination beneficial to the requesting company will be described.

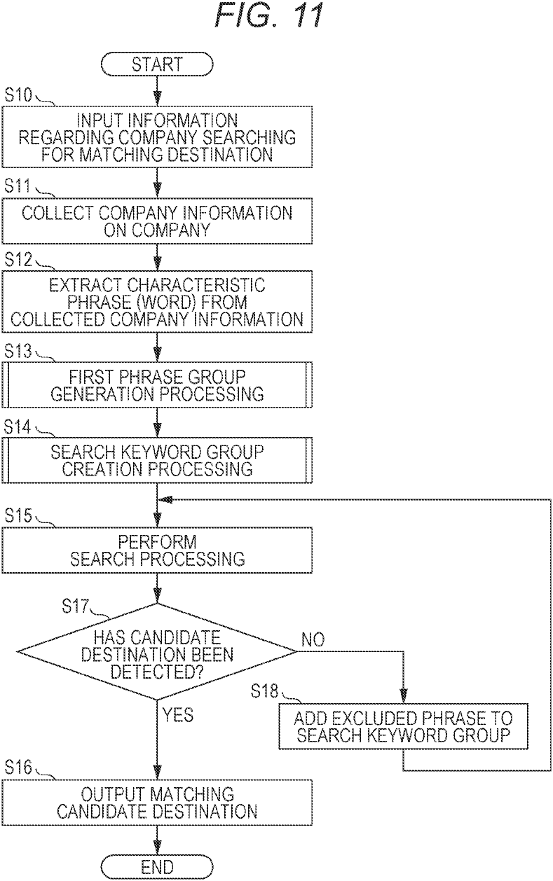

FIG. 11 is a flowchart illustrating a second example of a specific processing procedure of the support device 2. This processing is performed by the processor 10 of the support device 2 executing the program 12. The processing of steps S10 to S16 in the flowchart of FIG. 11 is similar to the processing of steps S10 to S16 in the flowchart of FIG. 4. The flowchart of FIG. 11 is different from the flowchart of FIG. 4 in that processing of steps S17 and S18 is performed after step S15. Hereinafter, the processing of steps S17 and S18 will be described in detail.

After performing search processing (step S15) using phrases included in the search keyword group GK created in step S14 as a keyword, the support device 2 determines whether or not a company that is a matching candidate destination of the requesting company has been detected (step S17). For example, the support device 2 displays a list of companies detected by the search processing (step S15) on the display unit 13, and receives a user’s operation performed on the operation input unit 14. The user checks the list of companies displayed on the display unit 13, and checks whether or not a company that is a matching candidate destination of the requesting company has been appropriately extracted. In a case where the matching candidate destination is appropriately extracted, the user performs an operation on the operation input unit 14 and inputs information indicating that the search result is good. On the other hand, in a case where the matching candidate destination is not appropriately extracted, the user performs an operation on the operation input unit 14 and inputs information indicating that the search result is not good. The support device 2 can determine whether or not a company that is a matching candidate destination of the requesting company has been detected on the basis of the information input by the user.

However, the present invention is not limited thereto, and the support device 2 may automatically determine whether or not a company that is a matching candidate destination of the requesting company has been detected. For example, by inputting information regarding a competitor of the requesting company to the support device 2 in advance, the support device 2 can automatically determine whether or not the company detected by the search processing is the competitor of the requesting company. Therefore, in a case where only the competitor of the requesting company is detected by the search processing, the support device 2 can automatically determine that the matching candidate company of the requesting company has not been detected.

In a case where the company that is the matching candidate destination of the requesting company has not been detected (NO in step S17), the support device 2 adds a phrase excluded from the first phrase group G1 when creating the search keyword group GK to the search keyword group GK (step S18). The phrase to be added is a phrase of a higher rank excluded from the first phrase group G1 as a phrase having a high possibility of being common with a phrase representing a competitor of the requesting company. Furthermore, the number of words to be added may be one or more. For example, as illustrated in FIG. 9, in a case where phrases of rank 1 to rank 8 are excluded in the first phrase group G1, the support device 2 adds at least one of the plurality of phrases of rank 1 to rank 8 to the search keyword group GK. Then, the search keyword group GK is updated.

Furthermore, when adding a phrase of a higher rank excluded from the first phrase group G1 to the search keyword group GK, the support device 2 may automatically select a phrase to be added, or may select a phrase to be added based on a user’s instruction. For example, in the case of automatically selecting a phrase to be added, the support device 2 may preferentially select a phrase of a higher rank among a plurality of phrases excluded from the first phrase group G1, or may preferentially select a phrase of a lower rank.

When adding a phrase to the search keyword group GK, the support device 2 executes the search processing (step S15) again. At this time, since the number of phrases included in the search keyword group GK is larger than that in the previous search, there is a high possibility that a company that is a matching candidate destination of the requesting company can be appropriately detected in the search processing again. Note that, in a case where a company that is a matching candidate destination of the requesting company has not been detected even in the search again (NO in step S17), the support device 2 further repeats processing of adding a phrase excluded from the first phrase group G1 to the search keyword group GK when creating the search keyword group GK (step S18).

As described above, the support device 2 according to the present example performs a search using the search keyword group GK created by excluding, in the first phrase group G1, a phrase of a high rank that is highly likely to be common with a phrase representing a competitor of the requesting company. In a case where a matching candidate destination of the requesting company cannot be detected, the support device 2 adds the excluded phrase of the high rank to the search keyword group GK and performs a re-search. As a result, there is a high possibility that the company that is the matching candidate destination of the requesting company can be appropriately detected, and convenience is improved.

For example, when the matching candidate destination of the requesting company is searched by applying the present example, a detection rate of a company suitable as the matching candidate destination of the requesting company is 40% or more. On the other hand, as a comparative example, when the search keyword group GK is created without performing the processing of step S32 in the flowchart of FIG. 6 and a search is performed using phrases included in the search keyword group GK, the detection rate of a company suitable as a matching candidate destination of the requesting company is less than 40%. That is, in the present example, since the detection rate of the competitor of the requesting company is lower than that in the comparative example, it is possible to improve the detection rate of the company suitable as the matching candidate destination of the requesting company.

### Third Example

Next, a third example will be described. In the first example described above, the plurality of phrases extracted from the company information are ranked according to the degree of importance, and phrases of a high rank that are highly likely to be common with phrases representing competitors of the requesting company are uniformly excluded. Therefore, there is a possibility that phrases that are excluded include phrases that do not correspond to phrases representing competitors. In the third example, a processing procedure capable of reducing the possibility that a phrase that does not correspond to a phrase representing a competitor is included in phrases excluded from the first phrase group G1 will be exemplified.

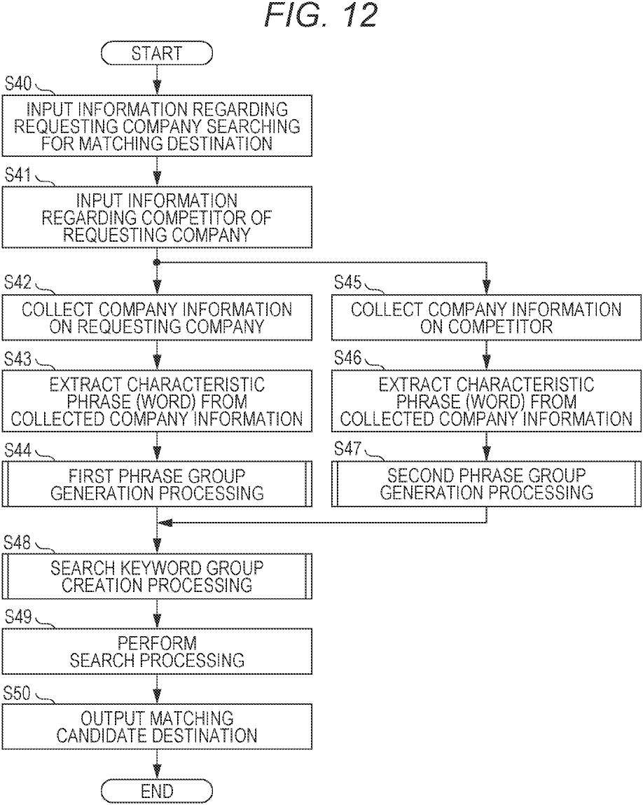

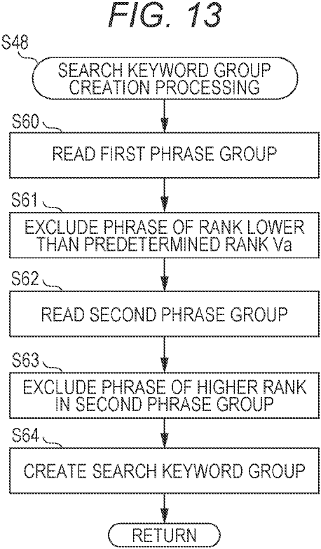

FIGS. 12 and 13 are flowcharts illustrating a third example of a specific processing procedure of the support device 2. This processing is performed by the processor 10 of the support device 2 executing the program 12. As illustrated in FIG. 12, when the support device 2 starts this processing, the support device 2 activates the requesting company input unit 20 to input information regarding the requesting company searching for a matching candidate destination (step S40). Furthermore, the support device 2 also inputs information regarding a competitor of the requesting company (step S41). The information regarding the competitor of the requesting company may be information including the name of the competitor or the like. Furthermore, the information regarding the competitor of the requesting company may be information of one company or information of a plurality of companies.

The support device 2 causes the company information acquisition unit 21 to function as information regarding the requesting company is input. Then, based on the information on the requesting company, the support device 2 collects company information on the requesting company from the company information providing device 4 including each of the Web servers 5, the company information server 6, and the patent information server 7 (step S42). After collecting the company information of the requesting company, the support device 2 causes the phrase extractor 22 to function. Then, the support device 2 extracts a characteristic phrase (word) regarding the requesting company from the company information of the requesting company (step S43). Subsequently, the support device 2 activates the keyword creation unit 23 to execute first phrase group generation processing (step S44). The first phrase group generation processing is similar to step S13 described in the first example. Therefore, by executing the first phrase group generation processing (step S44), the support device 2 generates a first phrase group G1 obtained by ranking a plurality of phrases extracted from the company information of the requesting company on the basis of the degree of importance as illustrated in FIG. 7, and stores the first phrase group G1 in the storage unit 11.

Furthermore, the support device 2 collects the company information on the competitor of the requesting company from the company information providing device 4 including each of the Web servers 5, the company information server 6, and the patent information server 7 on the basis of the information on the competitor of the requesting company (step S45). When the company information of the competitor of the requesting company is collected, the support device 2 causes the phrase extractor 22 to function. Then, the support device 2 performs processing similar to that in step S43, and extracts a characteristic phrase (word) regarding the competitor of the requesting company from the company information of the competitor of the requesting company (step S46). Subsequently, the support device 2 activates the keyword creation unit 23 to execute second phrase group generation processing (step S47). The second phrase group generation processing is similar to the processing in step S13 described in the first example. Therefore, the support device 2 executes the second phrase group generation processing (step S47) to generate a second phrase group obtained by ranking a plurality of phrases extracted from the company information of the competitor of the requesting company on the basis of the degree of importance.

For example, as illustrated in FIG. 12, the support device 2 executes the processing of steps S42 to S44 and the processing of steps S45 to S47 in parallel. As a result, the support device 2 can simultaneously perform the processing of generating the first phrase group and the processing of generating the second phrase group, thereby improving the processing efficiency.

Next, the support device 2 executes search keyword group creation processing (step S48). FIG. 13 is a flowchart illustrating a detailed processing procedure of the search keyword group creation processing. When starting the search keyword group creation processing (step S48), the keyword creation unit 23 reads the first phrase group G1 stored in the storage unit 11 (step S60).

Subsequently, the keyword creation unit 23 excludes a phrase arranged in a lower rank than the predetermined rank Va in the first phrase group G1 in order to prevent many companies that become noise components from being detected in the search processing (step S61). Note that, in a case where it is not necessary to prevent a large number of companies that become noise components from being detected, the processing of step S61 may not be performed.

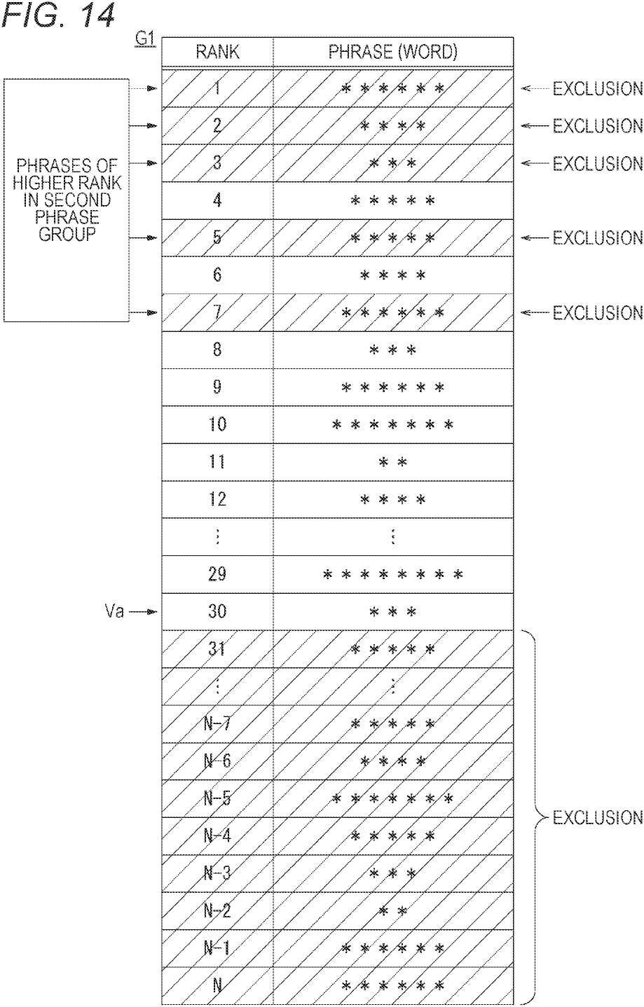

Next, the keyword creation unit 23 reads the second phrase group (step S62). In a case where a phrase common to a phrase included in a predetermined rank or higher in the second phrase group is included in the first phrase group G1, the keyword creation unit 23 excludes a phrase included in a higher rank of the second phrase group from the first phrase group G1 (step S63). For example, as illustrated in FIG. 14, in a case where phrases of rank 1, 2, 3, 5, and 7 in the first phrase group G1 are common to phrases of a higher rank in the second phrase group, the keyword creation unit 23 excludes phrases of rank 1, 2, 3, 5, and 7 from the first phrase group G1. A phrase included in a high rank in the second phrase group is a phrase having high importance for a competitor of the requesting company. Therefore, when a phrase of a higher rank in the second phrase group is included in the search keyword, a large number of competitors unsuitable as matching candidate destinations of the requesting company are detected. In order to prevent this, the keyword creation unit 23 excludes a phrase common to a phrase ranked high in the second phrase group from the first phrase group G1.

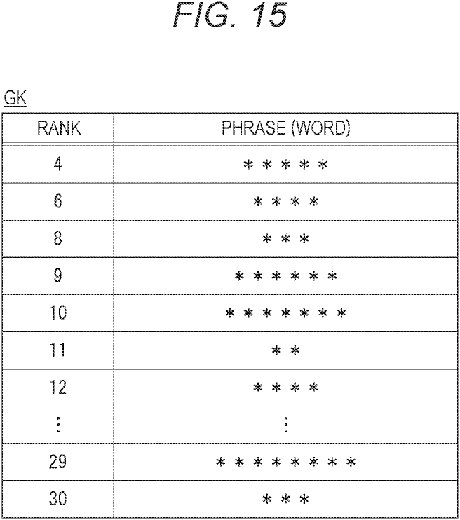

Next, the keyword creation unit 23 creates a search keyword group using phrases that are not excluded in the first phrase group G1 (step S64). FIG. 15 is a diagram illustrating an example of the search keyword group GK created from the first phrase group G1 in the present example. As illustrated in FIG. 15, the search keyword group GK does not include phrases of rank 1, 2, 3, 5, and 7 of the first phrase group G1. That is, a phrase having high importance for the competitor of the requesting company is excluded from the keywords (phrases) included in the search keyword group GK. Therefore, when the plurality of phrases included in the search keyword group GK are used to search for a company that is a matching candidate destination, the possibility that a competitor of the requesting company is detected can be reduced.

Furthermore, similarly to the first example, phrases having low importance for the requesting company are also excluded from phrases included in the search keyword group GK. Therefore, when a company that is a matching candidate destination is searched using a plurality of phrases included in the search keyword group GK, a possibility that a company that is not suitable as a matching candidate destination of the requesting company is detected can be suppressed to be low. Thus, the search keyword group creation processing ends.

Returning to the flowchart of FIG. 12, next, the support device 2 activates the search unit 24 and executes search processing (step S49). The search unit 24 searches for a company that is a matching candidate destination of the requesting company using a phrase (keyword) included in the search keyword group GK created by the keyword creation unit 23. In a case where a plurality of phrases are included in the search keyword group GK, the search unit 24 searches for a company as a matching candidate destination by performing an AND search or an OR search using the plurality of phrases. The search unit 24 can avoid detection of many competitors of the requesting company by performing a search using a phrase included in the search keyword group GK. Furthermore, in the search keyword group GK, the phrases of a lower rank in the first phrase group G1 are also excluded. Therefore, it is possible to avoid detection of many companies that are not competitors of the requesting company but are not suitable as matching candidate destinations of the requesting company. Therefore, the search unit 24 can efficiently detect the company that is the matching candidate destination of the requesting company by performing the search using the phrases included in the search keyword group GK. Thereafter, the support device 2 activates the output unit 25 and outputs the matching candidate destination detected by the search by the search unit 24 (step S50).

As described above, the support device 2 of the present example adopts, as a method of excluding a phrase representing a competitor of a requesting company from the plurality of phrases extracted from company information of the requesting company, a method of ranking the plurality of phrases extracted from the company information of the competitor of the requesting company according to the degree of importance, and excluding a phrase of a higher rank extracted from the company information of the competitor from the plurality of phrases extracted from the company information of the requesting company to create the search keyword group GK. By excluding a phrase having a high degree of importance for the competitor of the requesting company from the search keyword group GK, it is possible to effectively prevent the competitor of the requesting company from being detected when the matching candidate destination of the requesting company is searched in the support device 2, and there is an advantage that a search with high accuracy can be performed. Furthermore, according to the support device 2 of the present example, since it is possible to reduce the possibility that a phrase that does not correspond to a phrase representing the competitor is included in phrases excluded from the first phrase group G1, there is also an advantage that it is possible to avoid omission of a company that can be the matching candidate destination from a search target while satisfactorily avoiding detection of the competitor by search processing.

For example, when the matching candidate destination of the requesting company is searched by applying the present example, a detection rate of a company suitable as the matching candidate destination of the requesting company is 40% or more. On the other hand, as a comparative example, when the search keyword group GK is created without performing the processing of steps S62 and S63 in the flowchart of FIG. 13 and a search is performed using a phrase included in the search keyword group GK, the detection rate of a company appropriate to the matching candidate destination of the requesting company is less than 40%. That is, in the present example, since the detection rate of the competitor of the requesting company is lower than that in the comparative example, it is possible to improve the detection rate of the company suitable as the matching candidate destination of the requesting company.

Also in the present example, as described in the second example, it is determined whether or not the matching candidate destination of the requesting company has been detected after the search processing (step S49) is performed, and in a case where the matching candidate destination has not been detected, a phrase excluded in the search keyword group creation processing (step S48) may be added to the search keyword group GK and the search processing may be executed again.

### Fourth Example

Next, a fourth example will be described. In the fourth example, a processing procedure of generating the search keyword group GK using the company information of the existing business partner of the requesting company will be exemplified.

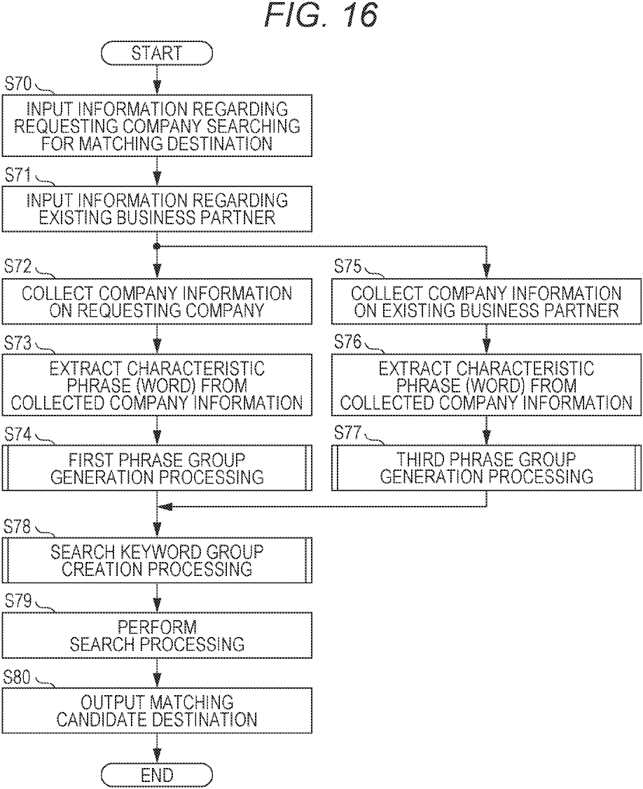

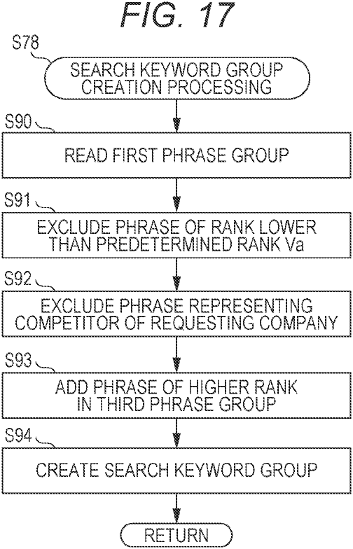

FIGS. 16 and 17 are flowcharts illustrating the fourth example of a specific processing procedure of the support device 2. This processing is performed by the processor 10 of the support device 2 executing the program 12. As illustrated in FIG. 16, when the support device 2 starts this processing, the support device 2 activates the requesting company input unit 20 to input information regarding the requesting company searching for a matching candidate destination (step S70). Furthermore, the support device 2 also inputs information regarding an existing business partner of the requesting company (step S71). The information regarding the existing business partner of the requesting company may be information including a company name or the like of the existing business partner. Furthermore, the information regarding the existing business partner may be information of one company or information of a plurality of companies.

The support device 2 causes the company information acquisition unit 21 to function as information regarding the requesting company is input. Then, based on the information on the requesting company, the support device 2 collects company information on the requesting company from the company information providing device 4 including each of the Web servers 5, the company information server 6, and the patent information server 7 (step S72). After collecting the company information of the requesting company, the support device 2 causes the phrase extractor 22 to function. Then, the support device 2 extracts a characteristic phrase (word) regarding the requesting company from the company information of the requesting company (step S73). Subsequently, the support device 2 activates the keyword creation unit 23 to execute first phrase group generation processing (step S74). The first phrase group generation processing is similar to step S13 described in the first example. Therefore, by executing the first phrase group generation processing (step S74), the support device 2 generates a first phrase group G1 obtained by ranking a plurality of phrases extracted from the company information of the requesting company on the basis of the degree of importance as illustrated in FIG. 7, and stores the first phrase group G1 in the storage unit 11.

Furthermore, the support device 2 collects the company information on the existing business partner of the requesting company from the company information providing device 4 including each of the Web servers 5, the company information server 6, and the patent information server 7 on the basis of the information on the existing business partner of the requesting company (step S75). When the company information of the existing business partner of the requesting company is collected, the support device 2 causes the phrase extractor 22 to function. Then, the support device 2 performs processing similar to that in step S73, and extracts a characteristic phrase (word) regarding a competitor of the requesting company from the company information of the existing business partner of the requesting company (step S76). Subsequently, the support device 2 activates the keyword creation unit 23 to execute third phrase group generation processing (step S77). The third phrase group generation processing is similar to step S13 described in the first example. Therefore, the support device 2 executes the third phrase group generation processing (step S77) to generate a third phrase group obtained by ranking a plurality of phrases extracted from the company information of the existing business partner of the requesting company on the basis of the importance.

For example, as illustrated in FIG. 16, the support device 2 executes the processing of steps S72 to S74 and the processing of steps S75 to S77 in parallel. As a result, the support device 2 can simultaneously perform the processing of generating the first phrase group and the processing of generating the third phrase group, thereby improving the processing efficiency.

Next, the support device 2 executes search keyword group creation processing (step S78). FIG. 17 is a flowchart illustrating a detailed processing procedure of the search keyword group creation processing. When starting the search keyword group creation processing (step S78), the keyword creation unit 23 reads the first phrase group G1 stored in the storage unit 11 (step S90).

Subsequently, the keyword creation unit 23 excludes a phrase arranged in a lower rank than the predetermined rank Va in the first phrase group G1 in order to prevent many companies that become noise components from being detected in the search processing (step S91). Note that, in a case where it is not necessary to prevent a large number of companies that become noise components from being detected, the processing of step S91 may not be performed.

Next, the keyword creation unit 23 excludes a phrase representing a competitor of the requesting company from a plurality of phrases included in the first phrase group G1 (step S92). Here, for example, as described in the first example, phrases ranked higher than the predetermined rank Vb in the first phrase group G1 may be excluded. Furthermore, for example, as described in the third example, a second phrase group in which a plurality of phrases extracted from the company information of the competitor of the requesting company are ranked based on the degree of importance may be generated, and a phrase common to a phrase included in a higher rank in the second phrase group may be excluded from the first phrase group G1. By excluding phrases representing the competitors of the requesting company from the first phrase group G1, it is possible to prevent a large number of competitors unsuitable for a matching candidate destination of the requesting company from being detected in the subsequent search processing.

Next, the keyword creation unit 23 adds, to the first phrase group G1, a phrase of a higher rank in the third phrase group obtained by ranking a plurality of phrases extracted from the company information of the existing business partner of the requesting company on the basis of the degree of importance (step S93). The phrase representing the existing business partner can be a valid keyword when searching for an appropriate matching candidate destination of the requesting company. Therefore, the keyword creation unit 23 adds a phrase ranked high in the third phrase group to the first phrase group G1 as a valid search keyword.

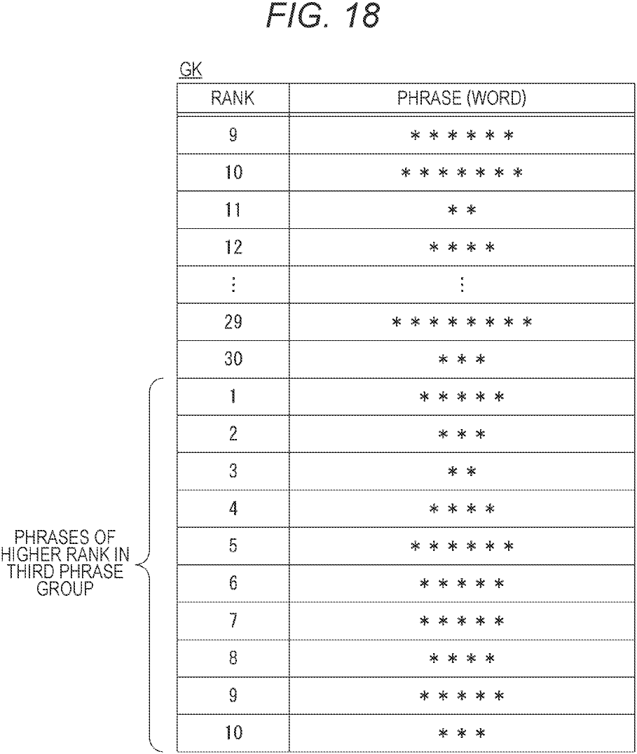

Then, the keyword creation unit 23 creates a search keyword group using the phrases recorded in the first phrase group G1 (step S94). FIG. 18 is a diagram illustrating an example of a search keyword group GK created from the first phrase group G1 in the present example. As illustrated in FIG. 18, in the search keyword group GK, phrases representing the competitors of the requesting company are excluded, and moreover, the search keyword group GK is a keyword group including phrases of a higher rank in the third phrase group. Therefore, when a matching candidate company is searched using a plurality of phrases included in the search keyword group GK, a possibility that a competitor of the requesting company is detected can be suppressed to be low, and a company similar to the existing business partner can be efficiently detected as a matching candidate destination.

Furthermore, similarly to the first example, a phrase having low importance for the requesting company in the first phrase group G1 is also excluded from the phrases included in the search keyword group GK. Therefore, when a company that is a matching candidate destination is searched using a plurality of phrases included in the search keyword group GK, a possibility that a company that is not suitable as a matching candidate destination of the requesting company is detected can be suppressed to be low. Thus, the search keyword group creation processing ends.

Returning to the flowchart of FIG. 16, next, the support device 2 activates the search unit 24 and executes search processing (step S79). The search unit 24 searches for a company that is a matching candidate destination of the requesting company using a phrase (keyword) included in the search keyword group GK created by the keyword creation unit 23. In a case where a plurality of phrases are included in the search keyword group GK, the search unit 24 searches for a company as a matching candidate destination by performing an AND search or an OR search using the plurality of phrases. The search unit 24 can avoid detection of many competitors of the requesting company by performing a search using a phrase included in the search keyword group GK. Furthermore, in the search keyword group GK, the phrases of a lower rank in the first phrase group G1 are also excluded. Therefore, it is possible to avoid detection of many companies that are not competitors of the requesting company but are not suitable as matching candidate destinations of the requesting company. Furthermore, since the search keyword group GK includes a phrase having high importance for the existing business partner of the requesting company, it is possible to reliably detect a company that can be a matching candidate destination. Therefore, the search unit 24 can efficiently detect the company that is the matching candidate destination of the requesting company by performing the search using the phrases included in the search keyword group GK. Thereafter, the support device 2 activates the output unit 25 and outputs the matching candidate destination detected by the search by the search unit 24 (step S80).

As described above, the support device 2 according to the present example creates the search keyword group GK by excluding the phrase representing the competitor of the requesting company from the plurality of phrases extracted from the company information and adding the phrase representing the existing business partner of the requesting company. Therefore, when searching for the matching candidate destinations of the requesting company, it is possible to effectively suppress detection of the competitor of the requesting company, and it is possible to detect the matching candidate destinations with high accuracy.

For example, when the matching candidate destination of the requesting company is searched by applying the present example, a detection rate of a company suitable as the matching candidate destination of the requesting company is 40% or more. On the other hand, as a comparative example, when the search keyword group GK is created without performing the processing of step S92 in the flowchart of FIG. 17 and a search is performed using a phrase included in the search keyword group GK, the detection rate of a company appropriate to the matching candidate destination of the requesting company is less than 40%. That is, in the present example, since the detection rate of the competitor of the requesting company is lower than that in the comparative example, it is possible to improve the detection rate of the company suitable as the matching candidate destination of the requesting company.

Also in the present example, as described in the second example, it is determined whether or not the matching candidate destination of the requesting company has been detected after the search processing (step S79) is performed, and in a case where the matching candidate destination has not been detected, a phrase excluded in the search keyword group creation processing (step S78) may be added to the search keyword group GK and the search processing may be executed again.

### Modified Example

The preferred examples of the present invention have been described above. However, the present invention is not limited to the contents described in the above examples, and various modifications can be applied.

For example, in the above example, the configuration example in which the support device 2 and the company information providing device 4 are connected via the communication network 3 has been described. However, the present invention is not limited thereto, and the support device 2 and the company information providing device 4 may be configured as an integrated device. Furthermore, in the above example, the case where the company information providing device 4 is configured by a plurality of servers has been exemplified, but the present invention is not limited thereto, and the company information providing device 4 may be configured by one device.

Furthermore, in the above example, the company introduction page D1, the product introduction page D2, the company information D3, and the patent information D4 are exemplified as the company information acquired by the support device 2 from the company information providing device 4. However, the company information acquired by the support device 2 from the company information providing device 4 is not limited thereto, and may be information other than these, or may further include other information.

Furthermore, in the examples described above, the program 12 executed by the processor 10 of the support device 2 is previously stored in the storage unit 11. However, the program 12 may be installed in the support device 2 via the communication network 3, for example. In this case, the program 12 is provided in a downloadable form via the Internet or the like. Furthermore, the present invention is not limited thereto, and the program 12 may be provided in a form of being recorded in a computer-readable recording medium such as a CD-ROM or a USB memory.

Furthermore, the service provided by the processor 10 executing the program 12 may be provided as, for example, software as a service (SaaS) via the Internet.

According to an embodiment of the present invention, it is possible to efficiently perform work when extracting a business matching candidate.

Although embodiments of the present invention have been described and illustrated in detail, the disclosed embodiments are made for purposes of illustration and example only and not limitation. The scope of the present invention should be interpreted by terms of the appended claims.

What is claimed is:

1. A business matching support device comprising:
a hardware processor that: acquires company information of a company searching for a matching candidate destination;
extracts a phrase relating to the company from the company information;
creates a search keyword group by excluding a phrase included in information on a competitor of the company from a plurality of the extracted phrases; and
searches a predetermined database using the search keyword group to extract the matching candidate destination.

2. The business matching support device according to claim 1, wherein the hardware processor generates a first phrase group obtained by ranking the plurality of extracted phrases based on an appearance frequency, and creates the search keyword group by further excluding a phrase of a lower rank from the first phrase group.

3. The business matching support device according to claim 2, wherein the hardware processor excludes a phrase included in the information of the competitor of the company by excluding a phrase of a higher rank from the first phrase group.

4. The business matching support device according to claim 3, wherein the hardware processor re-creates the search keyword group by adding at least one phrase deleted from the first phrase group.

5. The business matching support device according to claim 4, wherein when adding at least one phrase deleted from the first phrase group, the hardware processor selects a phrase to be added based on an instruction of a user.

6. The business matching support device according to claim 2, wherein the hardware processor generates a second phrase group obtained by ranking a plurality of the phrases included in the information of the competitor of the company based on an appearance frequency, and creates the search keyword group by excluding a phrase of a higher rank in the second phrase group from the first phrase group.

7. The business matching support device according to claim 1, wherein the hardware processor adds a phrase included in information of an existing business partner of the company to the search keyword group when creating the search keyword group.

8. The business matching support device according to claim 7, wherein the hardware processor generates a third phrase group obtained by ranking a plurality of the phrases included in the information on the existing business partner of the company based on an appearance frequency, and adds a phrase of a higher rank in the third phrase group to the search keyword group.

9. A business matching support method comprising:
acquiring company information of a company searching for a matching candidate destination;
extracting a phrase relating to the company from the company information;
creating a search keyword group by excluding a phrase included in information on a competitor of the company from a plurality of the phrases extracted by the extracting; and
searching a predetermined database using the search keyword group to extract the matching candidate destination.

10. The business matching support method according to claim 9, wherein the creating includes generating a first phrase group obtained by ranking the plurality of phrases extracted by the extracting based on an appearance frequency, and creating the search keyword group by further excluding a phrase of a lower rank from the first phrase group.

11. The business matching support method according to claim 10, wherein the creating includes excluding a phrase included in the information of the competitor of the company by excluding a phrase of a higher rank from the first phrase group.

12. The business matching support method according to claim 11, wherein the creating includes re-creating the search keyword group by adding at least one phrase deleted from the first phrase group.

13. The business matching support method according to claim 12, wherein when adding at least one phrase deleted from the first phrase group, the creating includes selecting a phrase to be added based on an instruction of a user.

14. The business matching support method according to claim 10, wherein the creating includes generating a second phrase group obtained by ranking a plurality of the phrases included in the information of the competitor of the company based on an appearance frequency, and creating the search keyword group by excluding a phrase of a higher rank in the second phrase group from the first phrase group.

15. The business matching support method according to claim 9, wherein the creating includes adding a phrase included in information of an existing business partner of the company to the search keyword group when creating the search keyword group.

16. The business matching support method according to claim 15, wherein the creating includes generating a third phrase group obtained by ranking a plurality of the phrases included in the information on the existing business partner of the company based on an appearance frequency, and adding a phrase of a higher rank in the third phrase group to the search keyword group.

17. A non-transitory recording medium storing a computer readable program causing a computer to perform:
acquiring company information of a company searching for a matching candidate destination;
extracting a phrase relating to the company from the company information;
creating a search keyword group by excluding a phrase included in information on a competitor of the company from a plurality of the phrases extracted by the extracting; and
searching a predetermined database using the search keyword group to extract the matching candidate destination.

18. The non-transitory recording medium storing a computer readable program according to claim 17, wherein the creating includes generating a first phrase group obtained by ranking the plurality of phrases extracted by the extracting based on an appearance frequency, and creating the search keyword group by further excluding a phrase of a lower rank from the first phrase group.

19. The non-transitory recording medium storing a computer readable program according to claim 18, wherein the creating includes excluding a phrase included in the information of the competitor of the company by excluding a phrase of a higher rank from the first phrase group.

20. The non-transitory recording medium storing a computer readable program according to claim 19, wherein the creating includes re-creating the search keyword group by adding at least one phrase deleted from the first phrase group.

21. The non-transitory recording medium storing a computer readable program according to claim 20, wherein when adding at least one phrase deleted from the first phrase group, the creating includes selecting a phrase to be added based on an instruction of a user.

22. The non-transitory recording medium storing a computer readable program according to claim 18, wherein the creating includes generating a second phrase group obtained by ranking a plurality of the phrases included in the information of the competitor of the company based on an appearance frequency, and creating the search keyword group by excluding a phrase of a higher rank in the second phrase group from the first phrase group.

23. The non-transitory recording medium storing a computer readable program according to claim 17, wherein the creating includes adding a phrase included in information of an existing business partner of the company to the search keyword group when creating the search keyword group.

24. The non-transitory recording medium storing a computer readable program according to claim 23, wherein the creating includes generating a third phrase group obtained by ranking a plurality of the phrases included in the information on the existing business partner of the company based on an appearance frequency, and adding a phrase of a higher rank in the third phrase group to the search keyword group.
